(19) United States
(12) Patent Application Publication
(10) Pub. No.: US 2006/0021318 A1
(43) Pub. Date: Feb. 2, 2006

(54) Pickup apparatus

(75) Inventors: Richard A. Briesemeister, Clear Lake, WI (US); George Arthur Michaels, Kent, NY (US); Bryn Briesemeister, Clear Lake, WI (US)

Correspondence Address: MERCHANT & GOULD PC, P.O. BOX 2903, MINNEAPOLIS, MN, 55402-0903, US

(73) Assignee: Oxbo International Corporation, Byron, NY (US)

(21) Appl. No.: 10/897,384

(22) Filed: Jul. 13, 2004

(51) Int. Cl. A01D 46/00

(52) U.S. Cl. 56/328.1

(57) ABSTRACT

An article pickup system includes rotating collector assemblies with radially, outward extending pickup members. The pickup members are spaced to engage and retain articles as the collector assembly advances. Separator chains extend intermediate the pickup members and loosen articles from the pickup members. The chains direct the articles to a conveyor system that transports the articles to a container. The speed and spacing of the chains and the spacing length and resiliency of the pickup members may be varied and may be different between the front and rear assemblies so that efficiencies are improved. The collector assemblies also include left and right hingedly connected portions so that the contact with the ground and the articles on the ground is increased.

### BACKGROUND OF THE INVENTION

1. Field of the Invention

The present invention relates to a pickup apparatus and in particular to an apparatus for picking up citrus fruit.

2. Description of the Prior Art

Devices for picking up articles such as fruit, nuts, golf balls and other articles that are generally found spread about on the ground are well known. Such devices often take the form of rotating drum type assemblies having elements extending outward that engage the articles and lift them from the ground. Such devices have proven to be satisfactory for picking up many types of articles. Where the articles have a consistent size, the pickup configuration can be optimized for the particular size of the articles.

However, greater difficulties are encountered when items are being picked up that may vary in size. The pickup systems must be spaced to accommodate the various sized items so that a high percentage are picked up. In addition, once the articles are lifted from the ground, they must be removed from the pickup device. Where the items have a consistent size, this is relatively straightforward. However, when the items vary in size, separating the items from the collector without damaging the items can be challenging. Problems may occur with jamming or with items being separated but not collected as some items fall back to the ground.

Examples of such prior art pickup devices include U.S. Pat. Nos. 5,025,620; 5,168,692; 1,859,980; 2,482,355; 3,888,370; 1,035,613; 1,104,431; 1,439,266, 3,746,099; 1,136,249; 1,191,814; 1,277,715; 4,066,179; 3,993,141 and 2,778,184.

Although these devices are generally satisfactory in picking up and collecting articles, none are able to pick up fruit that is not trapped on an initial pass or that may fall back to the ground when separated from the pickup device without making an additional pass.

It can be seen then that a new and improved pickup apparatus is needed. Such an apparatus should provide for following the contour of the ground and for picking up a high percentage of articles on the ground and transporting them to a collection device. Such a device should provide for engaging and picking up articles varying in shape and size in a single pass. Moreover, such a device should separate the articles picked up from the pickup device and direct them to a transport system or collection bin without allowing the articles to fall back to the ground. Such a device should be adaptable for towing from a harvester or mounting to a harvester. The present invention addresses these problems, as well as others associated with pickup devices.

### SUMMARY OF THE INVENTION

The present invention is directed to a pickup system and in particular, to a pickup system that may be adapted for picking up fruit or other articles. In one embodiment, the fruit pickup system includes a collector assembly having front and rear drum assemblies including left and right collector drums and front and rear drum assemblies, while in another embodiment, the collector includes left, center and right collector drums. A conveyor system transports the collected articles from the collector assembly to a receptacle. In one embodiment, the collector system mounts on a tractor with a support frame.

One embodiment of the collector assembly includes left and right collector drum assemblies that are pivotally connected to provide for travel over uneven terrain while increasing the engagement with the ground and the articles. The collector generally includes resilient pickup members spaced longitudinally and radially around the periphery of the collector drum assemblies. The pickup fingers are generally flexibly mounted and have a widened end portion so that articles falling between the fingers are retained by the widened end closing around the articles.

Separators remove the collected articles from the collector drum assemblies. The separators include separator chains spaced intermediate the series of pickup fingers. The articles are pulled from the collector drum assemblies by the separator chains and then transported onto a conveyor transverse to and intermediate the front and rear collector drums. In one embodiment, the positioning of the separator chains on the front collector drum assemblies is different than the positioning of the separator chains mounted on the rear collector drum assemblies. In the front collector drum assemblies, the separator chains generally extend rearward and upward so that articles are pulled from the fingers as they strike the underside of the chain and move rearward and downward onto the transverse conveyor. For the rear collector drum assemblies, the separator chains extend upward and forward. With this configuration, the articles in the rear collector drum assemblies are transported up and over the rotational axis of the drums and engage the upper surface of the separator chains. The separator chains extend frontward and upward to pull the articles from the drums and transport them to the transverse conveyor. The speed, location and spacing of the separator chains may be varied and may be different between the front and rear assemblies. Moreover, the resiliency, spacing, length and other parameters regarding the pickup members may also be varied and may be different between the front and rear collector drum assemblies.

The transverse conveyor generally moves the articles loosened from the collector assemblies to a rearward-extending conveyor that dumps the articles into a bin typically carried behind the motor vehicle.

The pickup system may also be configured to mount to a harvester device. The collector system transports fruit to the harvester's conveyor and moves laterally as the harvester conveyor extends and retracts.

These features of novelty and various other advantages that characterize the invention are pointed out with particularity in the claims annexed hereto and forming a part hereof. However, for a better understanding of the invention, its advantages, and the objects obtained by its use, reference should be made to the drawings that form a further part hereof, and to the accompanying descriptive matter, in which there is illustrated and described a preferred embodiment of the invention.

### BRIEF DESCRIPTION OF THE DRAWINGS

Referring now to the drawings, wherein like reference numerals and letters indicate corresponding structure throughout the several views:

FIG. 1 is a side elevational view of a pick up system according to the principles of the present invention;

FIG. 2 is a top plan view of the pick up system shown in FIG. 1;

FIG. 3 is a side elevational view of the collector assemblies for the pick up system shown in FIG. 1;

FIG. 4 is a top plan view of the collector assemblies shown in FIG. 3;

FIG. 5 is a rear elevational view of the collector assemblies shown in FIG. 3;

FIG. 6 is a top plan view of a drum and separator for one of the collector assemblies shown in FIG. 3;

FIG. 7 is a rear elevational view of the drum and separator shown in FIG. 6;

FIG. 8 is a top plan view of a drum for one of the collector assemblies shown in FIG. 3;

FIG. 9 is a rear elevational of the drum shown in FIG. 8;

FIG. 10 is a top plan view of a second embodiment of collector assemblies for a pickup system according to the principles of the present invention;

FIG. 11 is a rear elevational view of the collector assemblies shown in FIG. 10;

FIG. 12 is a rear elevational view of the collector assemblies shown in FIG. 11 with the assemblies pivoting relative to one another;

FIG. 13 is a top plan view of a third embodiment of a pickup system according to the principles of the present invention mounted on a citrus harvester;

FIG. 14 is a rear elevational view of the pickup system shown in FIG. 13 in an extended position;

FIG. 15 is a rear elevational view of the pickup system shown in FIG. 13 in a retracted position;

FIG. 16 is a side elevational view of the pickup system shown in FIG. 13 in an elevated position for travel;

FIG. 17 is a top plan view of a collector assembly for the pickup system shown in FIG. 13;

FIG. 18 is a side elevational view of the collector assembly shown in FIG. 17;

FIG. 19 is a side elevational view of the collector assembly and a portion of the tire of a citrus harvester;

FIG. 20 is a top plan view of a rotary sweeper device for the pickup system shown in FIG. 13; and

FIG. 21 is a rear elevational view of a collector drum for the collector assembly shown in FIG. 17 with the collector drum twisted.

### DETAILED DESCRIPTION OF THE PREFERRED EMBODIMENT

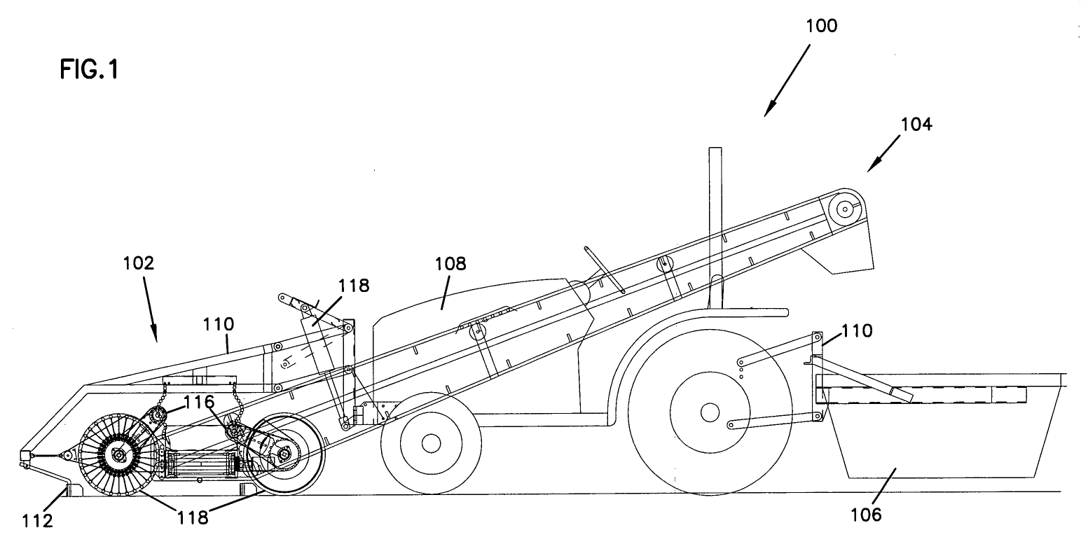

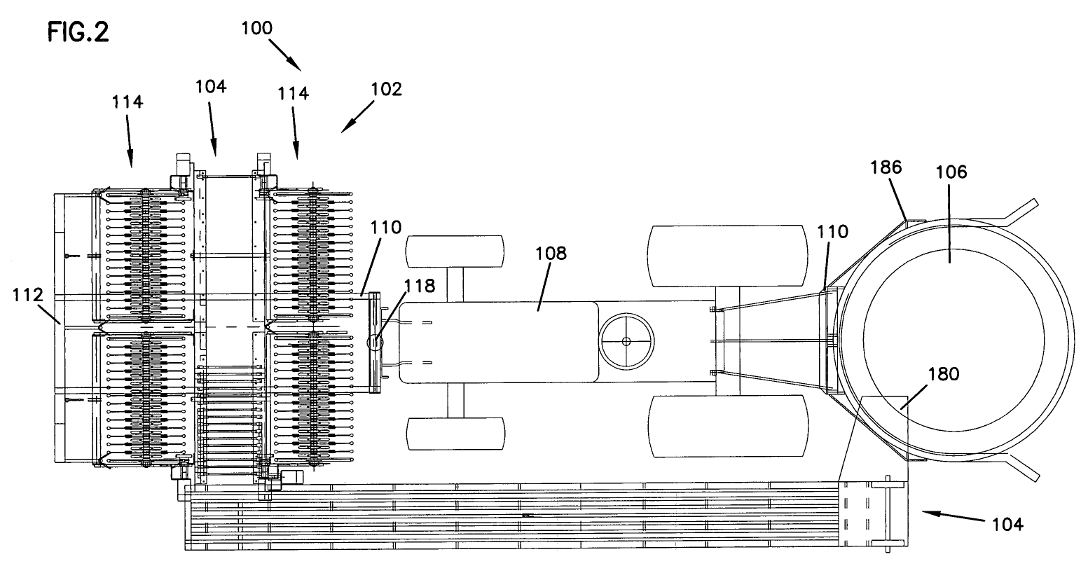

Referring now to the drawings, and in particular to FIGS. 1 and 2, there is shown a fruit pickup system, generally designated 100. The fruit pickup system 100 as shown is generally configured for picking up fruit such as citrus that has been removed from the tree and fallen to the ground. However, it can be appreciated that the present invention is adaptable to picking up articles of various sizes and is not limited to only citrus fruit. The pickup system 100 includes a collector assembly 102 mounted on a frame 110 to the front of a tractor 108. The support frame 110 assembly may be moved by a lift 118 in a conventional manner for transport when not in use. The pickup system 100 also includes a conveyor system 104 transporting collected articles from the collector assembly 102 to the rear of the tractor 108 and into a receptacle such as a removable tub or bin 106 supported on the frame 110. In a preferred embodiment, the bin 106 is interchangeable and may be removed and replaced with other empty bins 106, preferably by simply driving into and out from the bins, so that down time is minimized.

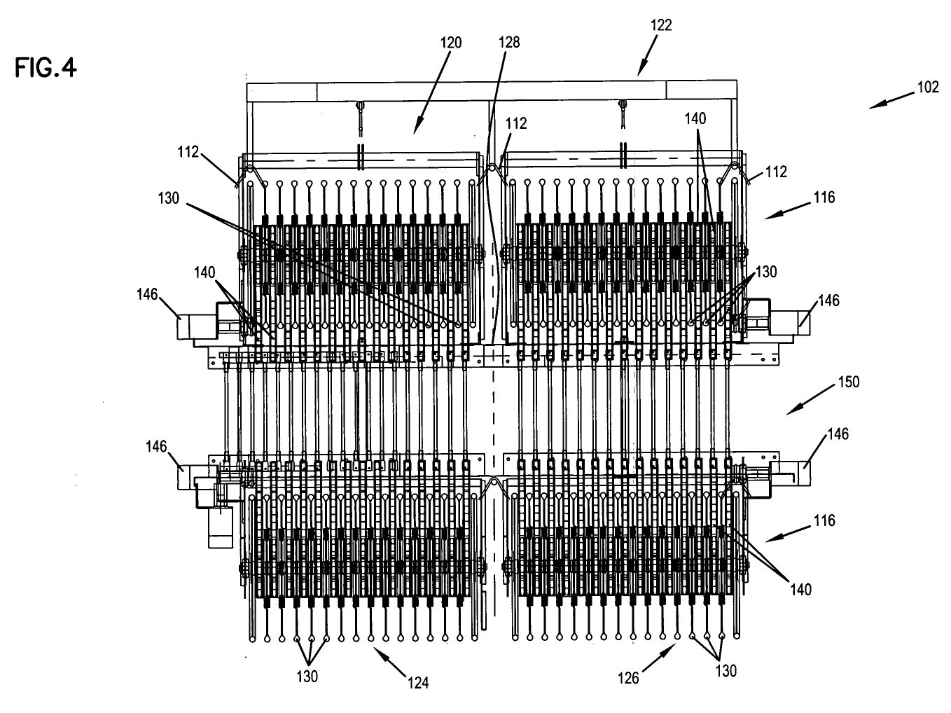

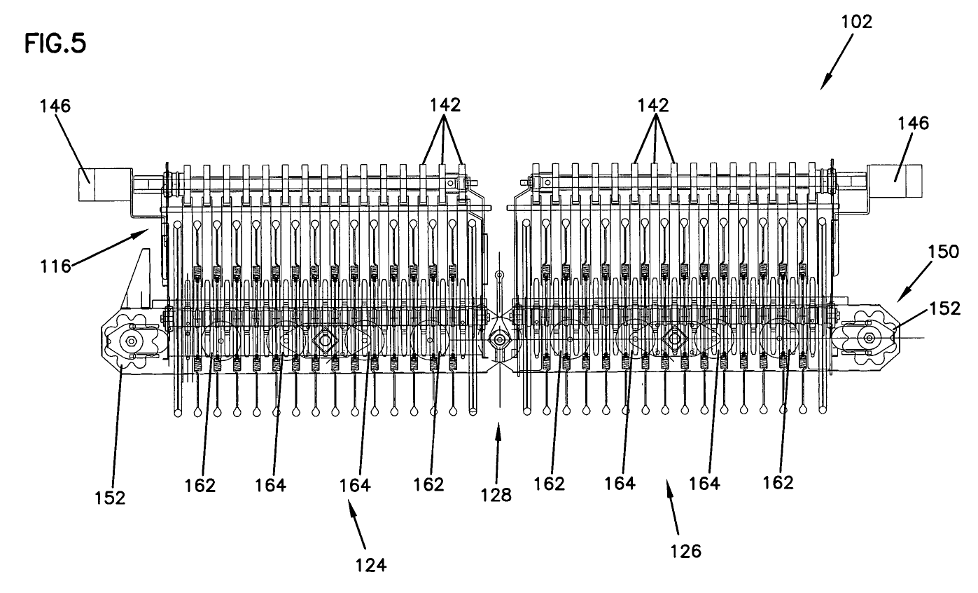

The collector assembly 102 includes collectors 114 and associated separators 116. In the embodiment shown, the front and rear collector 114 is shown including a left front drum assembly 120, a right front drum assembly 122, a left rear drum assembly 124 and a right rear drum assembly 126, as shown most clearly in FIGS. 2 and 4. A transversely traveling conveyor 150 runs intermediate the front and rear collectors 114. Moreover, the left and right drum assemblies of each pair are connected by a hinge 128, as shown most clearly in FIG. 5. Diverter members 112 are dragged on the ground to divert articles to the collector drum assemblies 120, 122, 124 and 126. The diverter members 112 are positioned at the ends of the drum assemblies as well as intermediate the left and right drum assemblies 120, 122, 124 and 126, in front of the hinges 128.

Each drum assembly 120, 122, 124 and 126, generally includes a plurality of radially extending fingers 130 spaced along the length and periphery of the drum assemblies 120, 122, 124 and 126. The drum assemblies 120, 122, 124 and 126 are constructed with sealed center bearings to improve reliability in a harsh operating environment. The pickup fingers 130 include a coiled spring mounting portion 134 or other flexible mounting arrangement so that the pickup fingers 130 are allowed to flex around articles as they are engaged. The ends of the pickup fingers 130 include widened portions 136 that maintain pressure against the articles and retain them so that the articles do not fall from between the pickup fingers 130 as they are lifted from the ground, as shown in FIGS. 1-3. An endmost set of pickup fingers 138 may be slightly more rigid or may be replaced with a wheel type member to provide added support for the collector drum assemblies 120-126. Depending upon the terrain, operating speed, articles to be picked up and other conditions, the collectors 114 may be driven or may be freely rotatable.

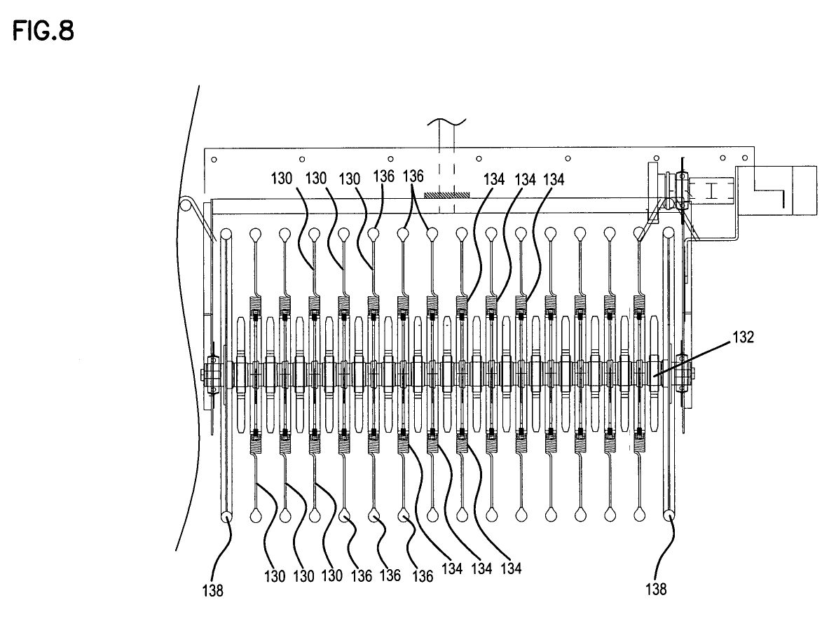

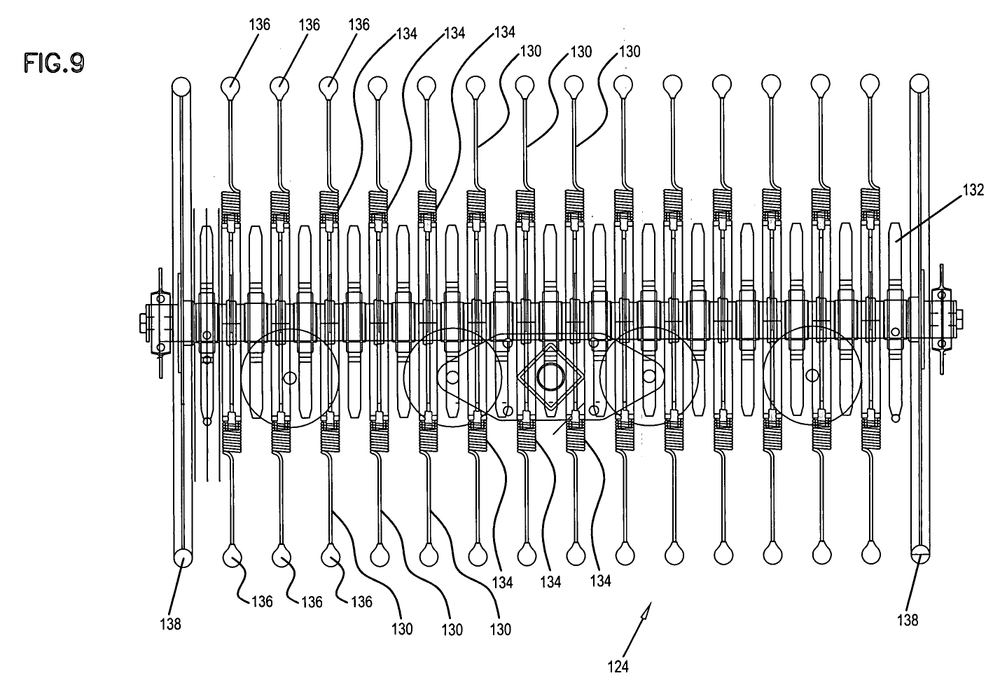

The drum assemblies 120-126 may be adapted for picking up different articles. For example, as shown in FIGS. 8 and 9, spacers 132 may be placed intermediate the sets of pickup fingers 130. The drum assemblies 120-126 are generally assembled by placing alternating sets of pickup fingers 130 with separate idler sprockets 144 for the separator, as explained hereinafter, and if needed, spacers 132. In this manner, different fingers having different spacing may be easily slid onto the collector drum assemblies 120-126 and removed so that they may be changed for picking up different types and sizes of articles. For example, spacing may be increased from a distance for picking up oranges to a distance for picking up grapefruit. Moreover, as the front drums 120 and 122 engage the articles before the rear drum assemblies 124 and 126, spacing between the front drum assemblies 120 and 122 and the rear drum assemblies 124 and 126 may be different. In this manner, each drum assembly may be targeted for picking up different sized articles and overall collection efficiency is increased. It has been found that in some conditions, pickup efficiencies of over 98% have been achieved with the present invention.

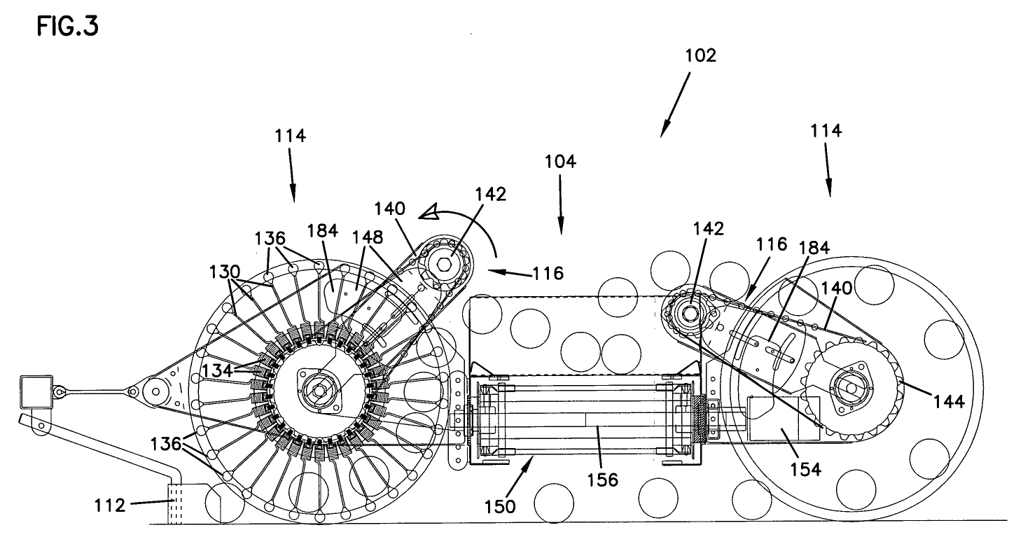

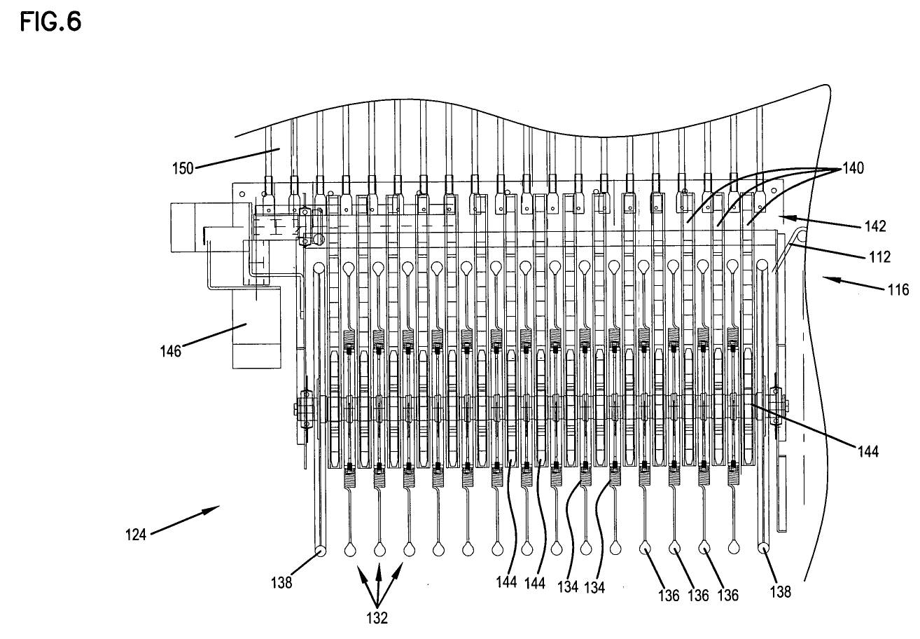

Referring now to FIGS. 3-6, each of the drum assemblies 120-126 includes an associated separator assembly 116. The separator assemblies 116 include a plurality of driven belts or chains 140 extending around the axis for the collector drum assemblies 120-126 and spaced intermediate the sets of pickup fingers 130. The chains 140 extend to a drive sprocket 142 generally spaced above the axis of rotation for the collector drum assemblies 120-126. The drive sprockets 142 for the front collectors 114 are spaced to the rear of the axis of rotation for the drum assemblies 120 and 122. The drive sprockets 142 for the rear collector drum assemblies 124 and 126 are spaced in front of the axis of rotation for the drum assemblies 124 and 126. As explained hereinafter, the removal efficiency and directing of the articles to the conveyor system 104 is improved with the arrangement of the present invention.

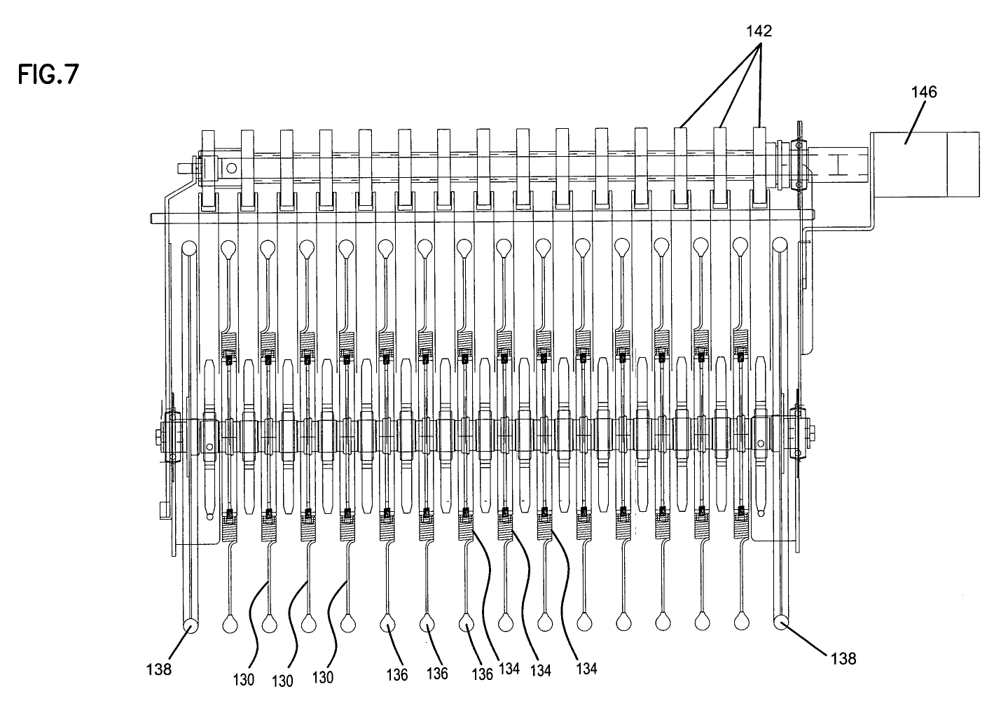

The sprockets 142 are mounted on a drive motor and shaft 146 as shown more clearly in FIGS. 4-7. The angular position of the drive sprockets 142 and motors 146 may be varied by moving the assembly relative to adjustment brackets 148.

The conveyor system 104 includes a transverse conveyor 150 shown most clearly in FIGS. 3 and 5. The transverse conveyor 150 includes end sprockets 152 and a drive motor 154. As shown in FIG. 3, a belt 156 extends transversely and may include transverse flanges to help move the articles. The conveyor belt 156 is supported on bogies 162 in a center bogie assembly 164. The conveyor belt 156 also extends around the hinge 128 to allow for pivoting of the left conveyor drum assemblies 120 and 124 relative to the right conveyor drum assemblies 122 and 126. As shown in FIG. 4, connectors 166 extend between the front and rear collectors 114 and below the upper portion of the belt 156. The conveyor 150 transports the articles to a rear conveyor 170, as explained hereinafter. It can be appreciated that with the arrangement of the present invention, a single transverse conveyor 150 serves both the front and rear collectors.

Referring to FIGS. 1 and 2, the rear conveyor assembly 170 includes a conveyor belt 172 driven by a motor 174. The conveyor 170 is supported by a frame 178, onto which pulleys or sprockets 176 are mounted. A rear chute 180 directs articles into the removable bin 106. The bin 106 is placed in a holder assembly 186 that retains the bin 106. The bin 106 is removed by setting it down and driving away. A new bin 106 is picked up by backing in and lifting, providing a system for easy removal when full and replacement.

In operation, the pickup system 100 is generally advanced so that the collector assembly 102 engages fallen articles on the ground. It can be appreciated that the collector assemblies 102 are hingedly connected so that greater contact with the contour of the uneven terrain is maintained. The increased contact improves collection efficiency greatly. It can further be appreciated that the front collector drum assemblies 120 and 122 may be configured differently than the rear collector drum assemblies 124 and 126 so that different size ranges of articles may be targeted, also increasing collection efficiencies.

As the collector system advances, articles engaging the diverters 112 are directed to the front collectors and either to the left front collector drum assembly 120 or the right collector drum assembly 122. The rotating drum assemblies 120 and 122 roll over the articles and the spaced apart pickup fingers 130 spread around the articles, as shown in FIG. 3. The fingers 130 flex but are resiliently mounted to extend partially around and trap the articles. The widened end portions 136 prevent the collected articles from simply falling out as they are moved backward and raised, as shown in FIG. 3. The pickup fingers 130 are shown removed from the rear collector 114 in FIG. 3 for greater clarity.

As shown in FIG. 3, when the front collector 114 transports the articles to the upper rear quadrant around the front collector drum assemblies 120 and 122, the articles engage the separator chains 140. The separator chains 140 not only pull the articles from the fingers 130, the chains 140 are driving radially outward from the axis of rotation of the collector drum assemblies 120 and 122. This orientation tends to also pull the articles rearward. The angle of the separator chains 140 knocks the articles both downward and rearward toward the transverse conveyor 150. Articles that may bounce back toward the front collector drum assemblies 120 and 122 are generally directed back onto the conveyor 150. The separator chains 140 are spaced so that jamming is minimized and alignment members 184 that are spaced intermediate the finger portions 130 assure that any bent fingers are diverted back toward their properly aligned orientation. This further reduces the possibility of jamming and other damage from bent pickup finger members 130. It has been found the excellent results have been achieved when the chains 140 operate at 2-3 times the ground speed.

Referring again to FIG. 3, the rear collector drum assemblies 124 and 126 pick up articles in a manner similar to the front collectors 120 and 122. However, separation and directing of the articles onto the conveyor 150 is slightly different. The picked up articles that are retained by the pickup fingers 130 and transported further around on the rear collector drum assemblies 124 and 126 to the top front quadrant before engaging the separator chains 140. The separator chains 140 rotate slightly upward and forward at the point where the articles first engage the chains 140. The separator chains 140 pull the articles loose from between the resilient pickup fingers 130 and knock them slightly upward and forward. The articles are transported by the chains 140 onto the conveyor 150. It can be appreciated that due to differences in sizes, the spacing between the pickup fingers 130 for the front collector drum assemblies 120 and 122 may be different than that for the rear collector drum assemblies 124 and 126, as shown in FIGS. 5-9. Moreover, the angle and speed of the separator chains 140 may be varied depending on the articles being collected. In addition, the speed and angle between the front and rear separators 116 may be different to optimize collection.

As shown in FIG. 2, the articles on the transverse conveyor 150 are moved from right to left until falling onto the rearward-extending conveyor 170. A chute 180 directs the articles into the tub 106.

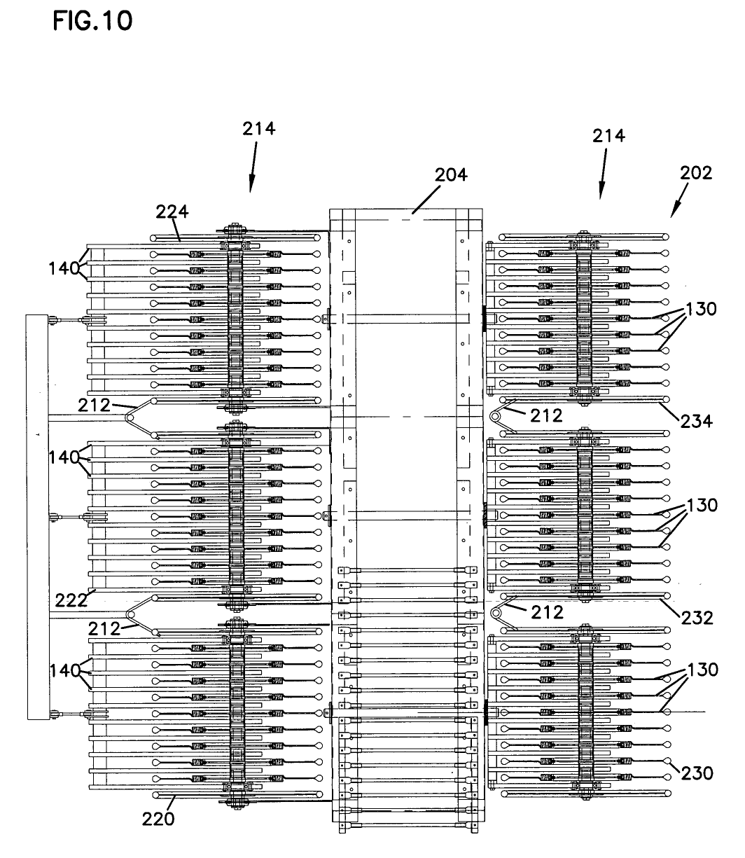

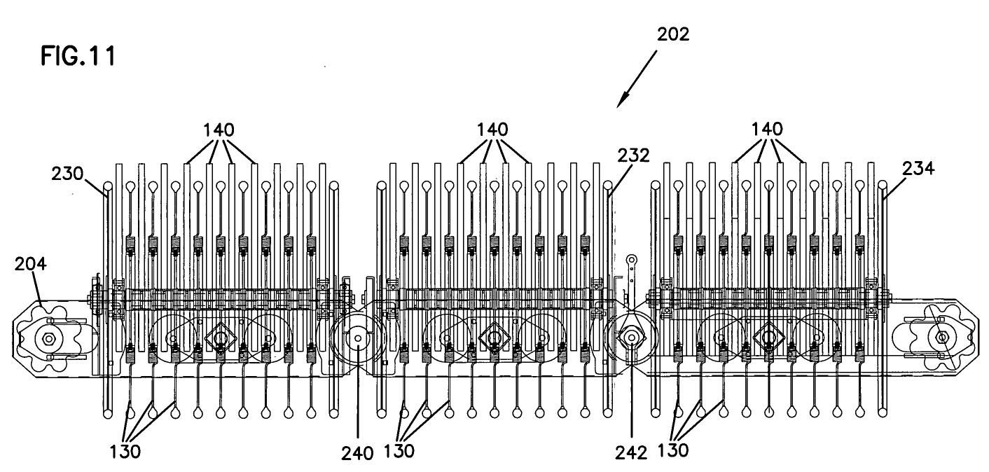

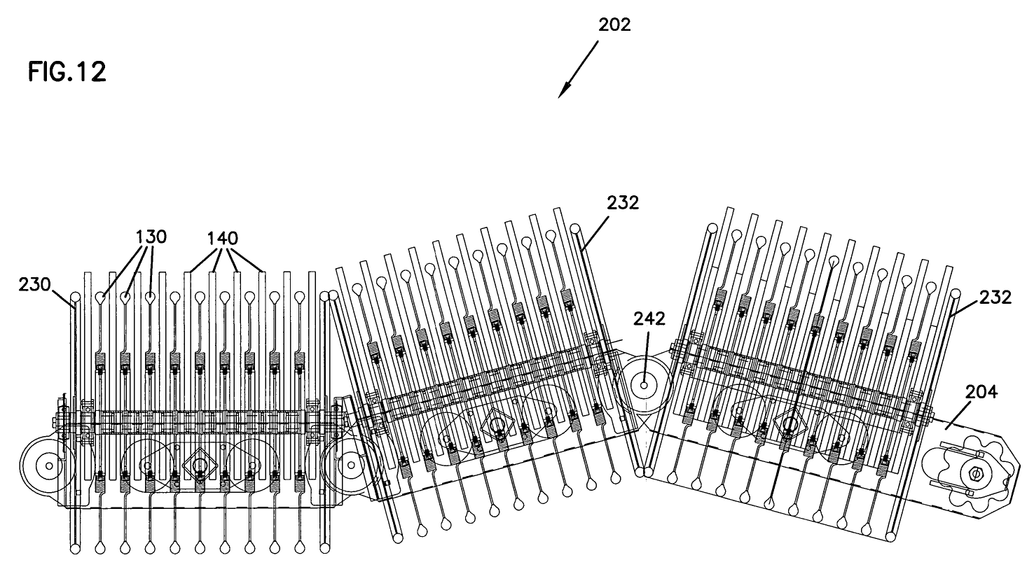

Referring now to FIGS. 10-12, there is shown a second embodiment of a collector assembly, generally designated 202. The collector assembly 202 is similar to the collector assembly 102, but includes three collector drums rather than two. The collector assembly 202 includes a conveyor 204 intermediate front and rear collectors 214. Diverters 212 direct the articles on the ground into the path of a collector drum. The collector assembly 202 includes a left front collector drum 220, a center front collector drum 222, a right front collector drum 224, a left rear collector drum 230, a center rear collector drum 232 and a right rear collector drum 234. The collector drums are similar to the collector drums shown in the first embodiment but may have a different width. In addition, the first and second pivots 240 and 242 provide an additional degree of freedom and relative movement between the various drums to more closely follow uneven terrain, as shown most clearly in FIG. 12. The pivots 240 and 242 allow for pivoting both up and down of the drum assemblies so that the terrain is more closely followed and pickup efficiencies are improved. Moreover, although the collectors 214 are shown with three drums, additional numbers could also be utilized for some applications. As additional collector drums are added, it can be appreciated that a pivotal connection intermediate the adjacent drums would also be added. Such an addition of collector drums would be similar to the additional drums and pivots disclosed herein.

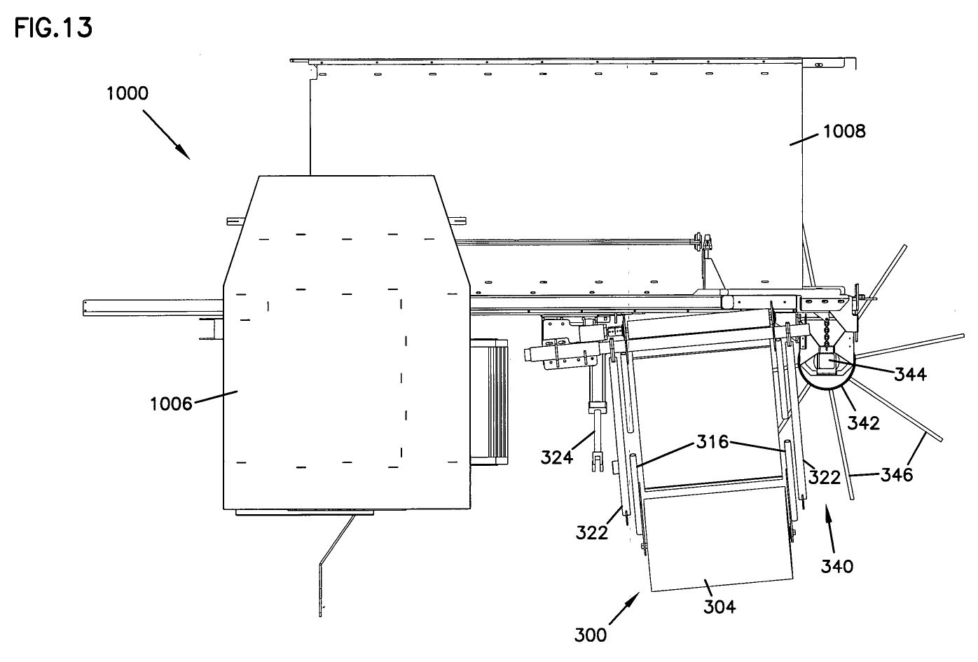

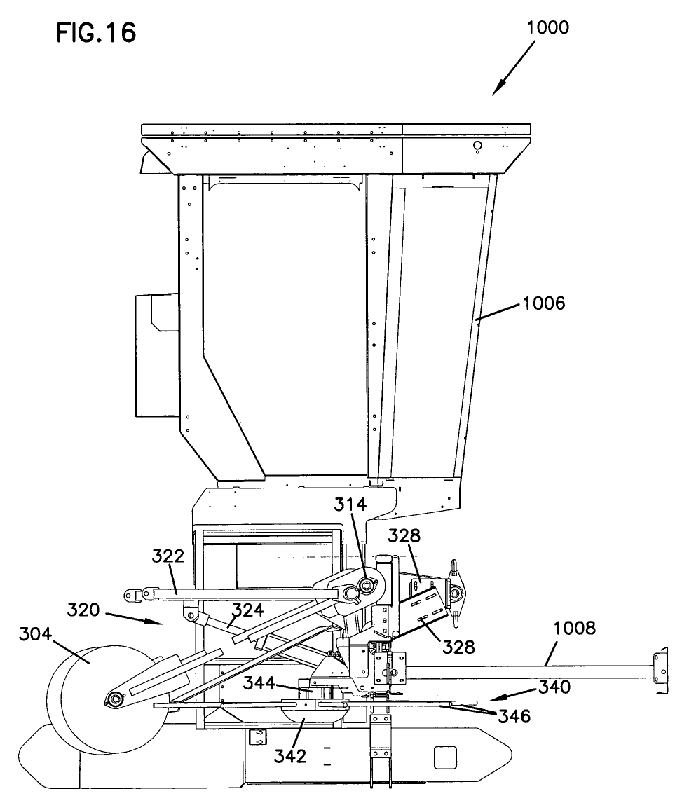

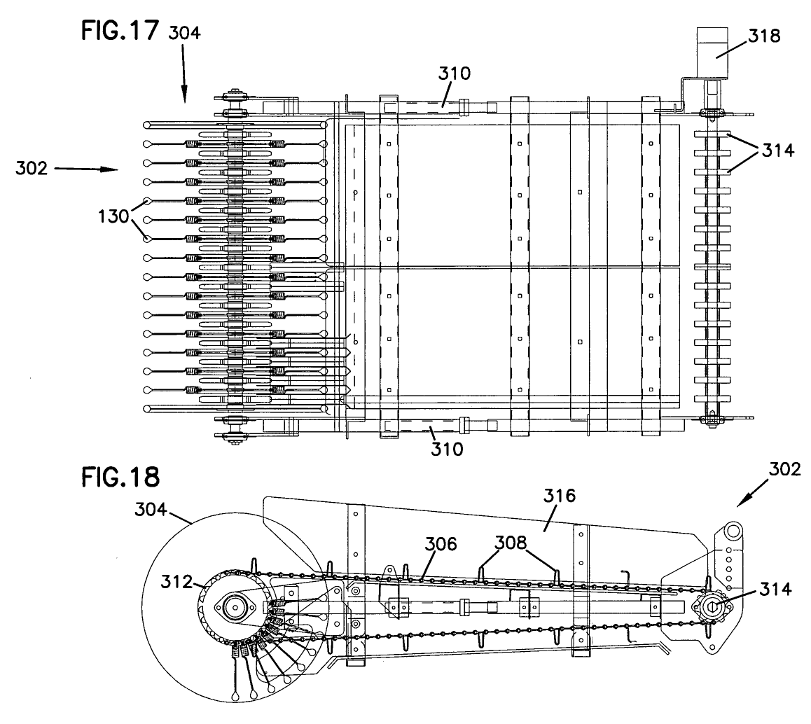

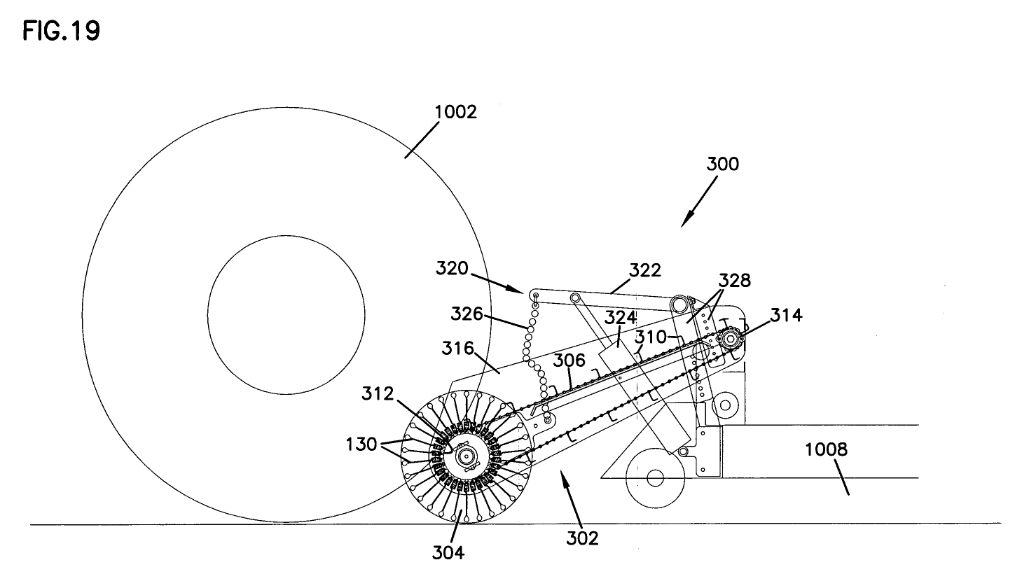

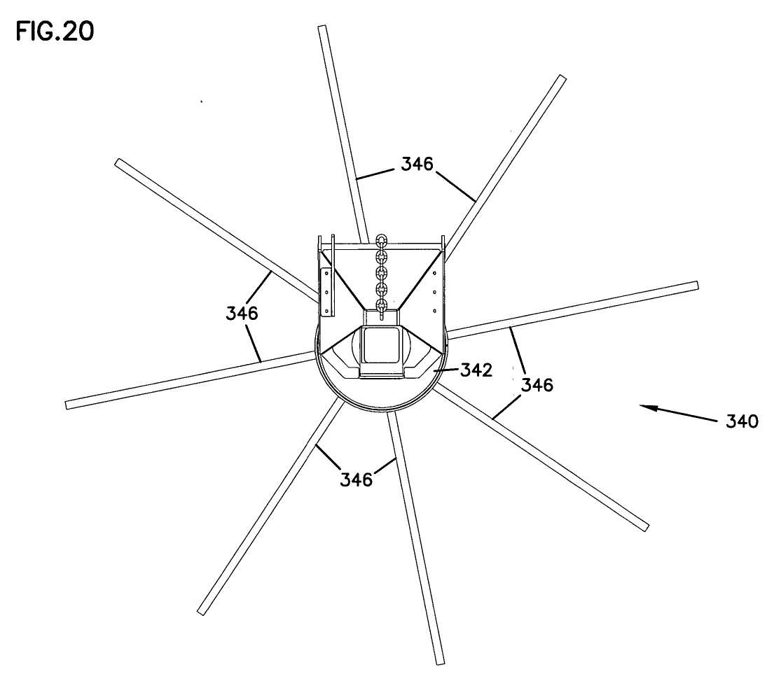

Referring now to FIGS. 13-21, there is shown a further embodiment of a pickup apparatus, generally designated 300. The pickup apparatus 300 is configured for mounting to a citrus harvester, generally designated 1000. A typical harvester is shown in U.S. Pat. No. 6,463,725 to Briesemeister. The harvester 1000 generally includes a frame 1004 mounted on wheels 1002. An operator cab 1006 is generally located toward the rear of the harvester 1000. A retractable and extendable conveyor 1008 moves in response to engagement with the citrus trees. Retractable plates 1010 extend from the edge of the conveyor 1008 and form a trunk seal to catch citrus fruit as it falls.

The pickup apparatus 300 includes a collector assembly 302 with a collector drum 304. Separator chains 306 pull the fruit from the drum in a manner similar to that shown in the collector apparatus 100. The chains may include cleats 308 or right angle cleats 310. The chains extend around a pulley or sprocket 312 and extend upward and around a drive sprocket 314.

A lift assembly 320 includes a support arm 322 and telescoping pistons 324. A chain 326 supports the collector assembly frame 316. Mounting plates 328 include adjustment holes for mounting and aligning the collector assembly.

A sweeper assembly 340 is at an extended end of the pickup apparatus 300. The sweeper assembly includes a hub having resilient sweeper elements 346 extending in a substantially horizontal plane. A hydraulic motor 344 drives the sweeper assembly 340. The sweeper elements 346 engage fallen citrus that is not collected by the harvester 1000 and propel it toward the collector assembly 302. The pickup apparatus 300 is mounted to the conveyor frame in one embodiment. The pickup apparatus 300 may also be mounted to the conveyor 1008 and extends and retracts as the conveyor extends and retracts. The resilient sweeper elements 346 extend beyond the edge of the trunk seal plates 1010, but direct the fallen fruit back toward the collector assembly 302.

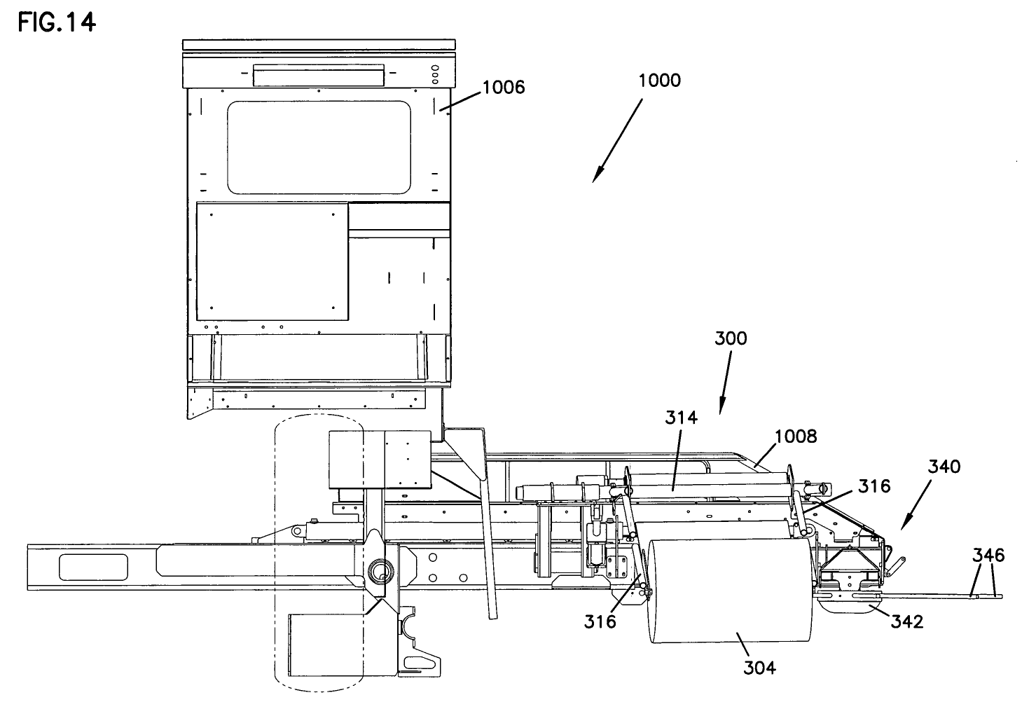

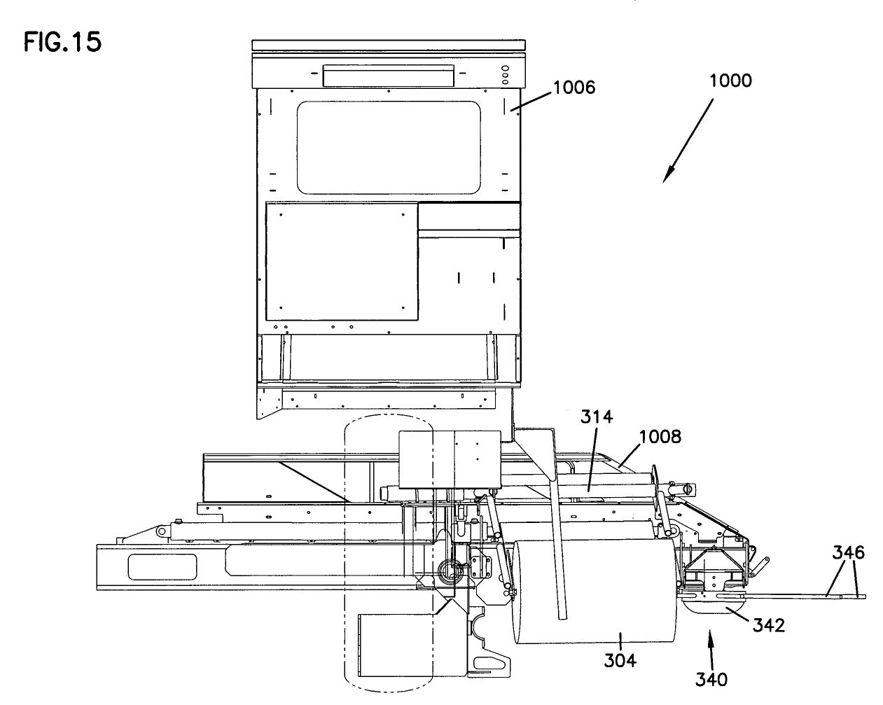

In operation, the collector assembly 302 is lowered to an operating position. The sweeper assembly 340 is engaged to direct fallen fruit back towards the collector assembly 302. When mounted to the conveyor 1008, the pickup apparatus 300 moves laterally inward and outward as shown in FIGS. 14 and 15. Although a right hand pickup apparatus is shown, it can be appreciated that a similar left side version is also used. Moreover, as the citrus harvesters are left handed and right handed, the mounting and relative position of the elements are simply reversed. As the fruit is engaged by the collector assembly 302, the fingers 130 engage the fruit and lift it around until striking the chains 306. The separator chains 306 then pull the fruit out from between the fingers 130. The cleats 308 or 310 then lift the separated fruit upward where it is deposited back on the conveyor for transport to a receptacle.

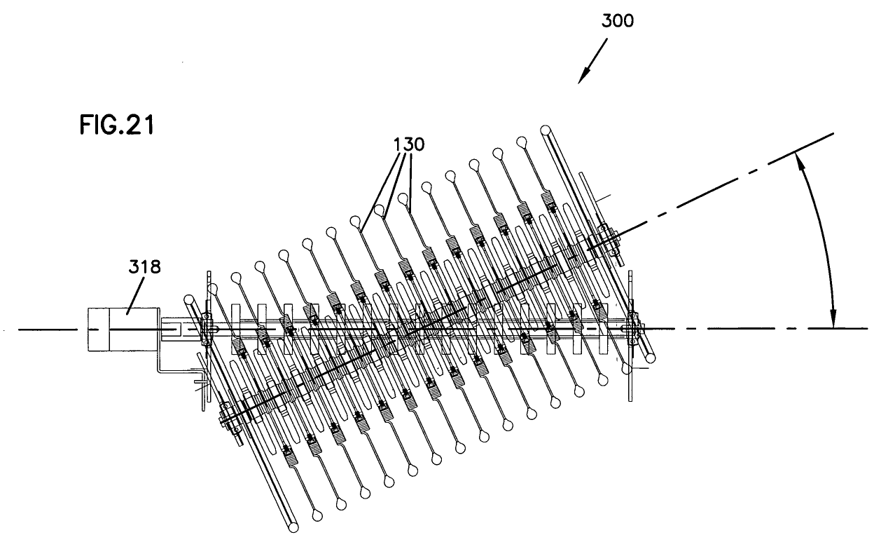

As shown in FIG. 21, the collector assembly 302 is mounted to provide for flexure relative to the harvester. Therefore, as the collector assembly 302 travels over uneven terrain, it is allowed to twist and follow the terrain. This increases the contact with the ground and improves pickup efficiency.

It can be appreciated that the present invention achieves a pickup system that can adapt to picking up and transporting a variety of different sized articles with high efficiency. The present invention provides a durable, reliable and inexpensive pickup system. Moreover, the present invention achieves high efficiencies even over uneven terrain without requiring a second pass.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1-19. (canceled)

20. An article pick up system, comprising:
a container;
a rotating collector assembly having a first axis including a plurality of radially outward extending pick up members, the pick up members spaced apart so as to engage and retain articles as the collector assembly advances;
a separator for removing articles from the collector assembly;
a conveyor receiving articles removed from the collector assembly and transporting the articles to the container.

21. A system according to claim 20, further comprising a motive device for advancing the article pick up system.

22. A system according to claim 20, wherein the collector assembly comprises:
a first rotating collector assembly;
a second rotating collector assembly, wherein the first collector assembly precedes the second collector assembly along a direction of travel.

23. A system according to claim 20, wherein the separator comprises a plurality of chains extending along a length of the collector assembly, wherein a chain is intermediate adjacent rows of the pick up members.

24. A system according to claim 23, wherein the chains are driven.

25-40. (canceled)

41. A system according to claim 20, wherein the collector assembly comprises a first collection portion, a second collector portion coaxial with the first collector portion and a hinge connecting the first collector portion to the second collector portion.

42. A system according to claim 20, wherein the collector assembly is configured to be mounted to an agricultural harvester.

43. A system according to claim 20, wherein the pick up members comprise resilient members.

44. A system according to claim 20, wherein the pick up members comprise a widened end portion.

45. A system according to claim 20, further comprising a lift apparatus for raising and lowering the collector assembly between a travel position and a use position.
